(19) United States
(12) Patent Application Publication
(10) Pub. No.: US 2002/0107702 A1
(43) Pub. Date: Aug. 8, 2002

(54) Method of developing a product while considering quality features of the product

(76) Inventor: Michael Diehl, Munchen (DE)

Correspondence Address: MORRISON & FOERSTER LLP, 2000 PENNSYLVANIA AVE, NW, SUITE 5500, WASHINGTON, DC, 20006-1888, US

(21) Appl. No.: 10/038,876

(22) Filed: Jan. 8, 2002

(30) Foreign Application Priority Data
Jan. 9, 2001 (EP) 01100514.7

(51) Int. Cl. G06F 17/60

(52) U.S. Cl. 705/1

(57) ABSTRACT

The invention relates to a method in which at least two components (22 to 30) which are to be included in the product (20) are defined for a product (20) to be developed. In a test procedure it is checked for each component (22 to 30) whether the characteristic product quality values established for the product are achieved by the characteristic component quality values determined for this component (22 to 30) even when this component (22 to 30) is combined with further components (22 to 30). If the result of the test is negative, the component (22 to 30) is modified and the test procedure is repeated.

The invention relates to a method of developing a product while taking into consideration quality features of the product to be established. Characteristic sales values which relate at least to the intended sales region are established for the product to be developed. In the method, furthermore, the characteristic product quality values to be satisfied by the product are established, consideration being given to the regulations and guidelines arising from the characteristic sales values. At least two components which are to be included in the product are defined for the product.

To be able to sell products, it is necessary that these products satisfy the legal regulations and guidelines which apply in the respective sales region. If the products are to be sold to customers who impose their own requirements and guidelines on such products, it is necessary that the respective product also satisfies these regulations and guidelines. Such requirements may be, for example, accident prevention regulations, vehicle registration regulations, requirements in terms of fire behavior, earthquake safety and electromagnetic compatibility (EMC), safety regulations, works standards and environmental protection regulations.

For example, to be able to use screens of personal computers at video workstations in Germany, the screen must satisfy the characteristic values established in the internationally recognized TCO standards of the Swedish central organization of professional employees, since compliance with the TCO standards is also prescribed in Germany. Such a screen must also undergo a CE test procedure, in which the screen is tested for electromagnetic compatibility and interference immunity.

Furthermore, the screen should undergo equipment safety testing by the appropriate trade association, in Germany the VDE or the TÜV, a test sticker attesting to the safety of the equipment being awarded if the characteristic values of the equipment safety test are met. If operation of the screen in a power-saving mode is intended, the screen should conform to the standards and provisions of the American Environmental Protection Agency EPA, which are recognized as an international standard and according to which the screen must have a maximum power consumption of 30 watts in the power-saving mode. If it conforms to these standards and provisions, the screen is given what is known as an Energystar test sticker.

For switching the monitor over to the power-saving mode, the internationally applicable DPMS (Digital Power Management Signaling) standards and provisions of the VESA (Video Electronics Standard Association) should be taken into consideration. Such standardization ensures that the power management system of the screen can also be switched to the power-saving mode with the aid of a screen driving board, the output signals of which correspond to the DPMS standards and provisions of the VESA. The DPMS standards and provisions also include, for example, the type and color of a voltage supply monitoring display and the state of such a display.

If such a screen is to be sold not only in Germany but also in the USA, the UL construction regulations for electronic equipment applicable in the USA must be additionally taken into consideration. If, however, such a screen is to be sold and used in an area with a subtropical climate, the increased requirements for the climatic resistance of the screen, in particular in respect of the increased atmospheric humidity and temperature of the ambience, must be taken into consideration during the development of the screen.

During the development of air-conditioning systems for motor vehicles, it must be taken into consideration for example that in certain sales areas, for example in Germany, no refrigerant containing chlorofluorocarbons may be used.

In the case of devices for encoding data, different encoding algorithms are legally prescribed for example in the USA than in India. If the type of encoding method is not legally prescribed for a particular application and/or in a sales area, they may be prescribed for example by guidelines of possible customers. Major companies and concerns have their own regulations and guidelines which have to be met by suppliers. For example, Deutsche Telekom AG has its own guidelines for telecommunication equipment, with the designation 1TR9. What are known as works standards, comprising guidelines and standards which suppliers have to meet, are also widespread in other branches of industry, such as the chemical industry or the automobile industry for example.

If the products to be developed are to be used and sold in countries in which it is prescribed that the components of the product must be manufactured by indigenous manufacturers, this must also be taken into consideration already during the product development. For example, it is customary that in the case of state-owned telephone companies and public invitations to tender, regulations which compulsorily prescribe indigenous manufacturers for the components used apply.

In known methods for the quality assurance of products to be developed, it is often the case that the fully developed products do not meet all the quality requirements. In order nevertheless to satisfy all the quality requirements, cost-intensive subsequent improvements of the products, even including the exchange of entire components, are required.

The object of the invention is to provide a method of developing a product in which the characteristic quality values of the product satisfy the decisive regulations and guidelines.

This object is achieved for a method of developing a product by the features of claim 1. Advantageous embodiments of the invention are specified in the dependent claims.

A method with the features of claim 1 makes it possible for the regulations and guidelines arising from the characteristic sales values to be taken into consideration already during product development.

Furthermore, by this method, every component of the product is tested in such a way that the characteristic product quality values to be satisfied, arising from the regulations and guidelines, are achieved even when this component is combined with further components. The components are modified already during the development in such a way that they satisfy the established characteristic product quality values. A subsequent improvement of the components is consequently not necessary once the development of the product has been completed, since the characteristic values of the developed product already satisfy all the relevant regulations and guidelines. It is also possible by this method to take a decision already during the development of the product as to whether different embodiments of the product are to be developed for different sales regions or whether a product which satisfies all the requirements, regulations and guidelines which arise from the established characteristic sales values is developed. The characteristic product quality values represent desired values and the current determined characteristic component and/or product quality values represent actual values. With the aid of the method according to patent claim 1, a set-value/actual-value comparison is carried out in the manner of a control loop. The modification of the respective component or components is the manipulated variable of the control loop. The control is carried out until the actual values have at least reached the desired values.

In one embodiment of the invention, the characteristic product quality values are determined from the possibly modified characteristic component quality values using a method of evaluation, with empirical estimating methods, mathematical models and simulation methods being used for example as methods of evaluation. If modified characteristic component quality values have been determined, the characteristic product quality values are determined from them using the method of evaluation. This achieves the effect that characteristic product quality values which can be compared with the characteristic product quality values to be satisfied are determined, the product satisfying all the relevant regulations and guidelines if the result of the comparison is positive.

In a further embodiment of the invention, the characteristic product quality values are determined by direct measuring and/or testing on the product. In comparison with the characteristic product quality values determined from the characteristic component quality values, the characteristic product quality values determined by measurements and/or tests offer greater accuracy for the characteristic product quality values actually achieved.

In an advantageous embodiment of the invention, the components are hardware components and/or software components. It is consequently ensured that all the characteristic product quality values which are influenced by hardware components and/or software components are correctly determined.

In another embodiment of the invention, characteristic quality variables possible manufacturers of the individual components are also taken into consideration in the definition of the components. Such characteristic quality variables are, for example, the performance capability, the commercial situation and/or the quality of manufactured products of the respective manufacturer. The determination of the characteristic quality values of the manufacturers may be carried out with the aid of a questionnaire, which also contains information on the established characteristic product quality values for the product to be developed.

The respective possible manufacturer may declare, for example, on the questionnaire that there are possibilities for tests which adequately demonstrate that the established characteristic product quality values are met and that said manufacturer will carry out this test if commissioned with an order to do so. Consequently, it is ensured that the component manufactured by this manufacturer satisfies the established characteristic product quality values. The manufacturer may also declare its readiness, if commissioned with an order to manufacture a component, to carry out the necessary tests and possibly necessary modifications of the component to satisfy the established characteristic product quality values.

The respective manufacturer should also declare before conclusion of a contract its readiness to surrender to the commissioning agent documentation on the determined characteristic component quality values and/or the determined characteristic product quality values soon after they are determined, and to allow such documentation to be passed on to third parties, in particular to final customers. It is consequently not only ensured that the established characteristic product quality values are met and satisfied but also possible to provide documentation to third parties, for example test agencies and final customers, showing that there is compliance with regulations and guidelines.

In another advantageous embodiment of the invention, the possible manufacturer of the component names at least one contact who will be available during the determination of the characteristic product quality values and, if need be, provide support for the values in subsequent testing and modification of the component. This ensures that the manufacturer of the component provides active support in satisfying the established characteristic product quality values.

In a further embodiment of the invention, it is taken in to consideration during the definition of the component and/or when establishing the possible manufacturers that there are at least two manufacturers who can manufacture the respective component. This achieves the effect that, if there are problems with one manufacturer, there is another manufacturer which can supply the respective component. This excludes any dependence on a single manufacturer. It also allows a more favorable price-performance ratio to be achieved in contract negotiations.

It is advantageous if, in a further embodiment of the invention, in the event that the components of the product: are to be manufactured by more than one manufacturer, a manufacturer responsible for meeting the established characteristic product quality values is established. This achieves the effect that the responsibilities are clearly defined, thereby avoiding problems of accountability between the individual manufacturers.

Furthermore, it is advantageous that it is contractually agreed with the manufacturer of the respective component at least that the established characteristic product quality values will be met and/or characteristic component quality values which arise for the respective component from the characteristic product quality values will be met. This ensures that the established characteristic product quality values and the characteristic component quality values arising for the respective component from the characteristic product quality values will be met without extra costs.

In a further embodiment of the invention, the determined characteristic quality values are confirmed by an accredited test laboratory. This achieves the effect that the characteristic quality values are correctly determined with adequate accuracy under the conditions presented in the guidelines and regulations. The recognition of these determined values also by possible customers, approval registration agencies and inspection associations is consequently ensured.

In another embodiment of the invention, the characteristic product quality values are not determined by direct measurement and/or testing if it is not only the case that the individual components satisfy the established characteristic product quality values but it is also unlikely that the components will influence one another. This achieves the effect that the characteristic component quality values of the component are determined without verifying whether the determined characteristic component quality values reach the established characteristic product quality values even when this component is combined with the further component. In particular in the case of components for which it is improbable or impossible that they will influence one another in a way causing the characteristic product quality values to be exceeded, it is possible to dispense with the laborious determination of the characteristic product quality values and/or the laborious determination of the characteristic component quality values while taking into consideration the influences of other components. A relatively high amount of expenditure in terms of work, cost and time can be avoided in this way.

It is also advantageous if, when establishing the characteristic quality values, characteristic values for CE marking, for UL approval, for NEBS approval, country-specific standards, in particular on earthquake safety, on the permissible fire load and on electromagnetic compatibility, environmental protection regulations and/or special customer requirements for characteristic quality values are taken into consideration. This achieves the effect that the relevant regulations and guidelines are already taken into consideration during the product development.

It is also advantageous to archive the characteristic product quality values determined and/or arising for the product from the characteristic component quality values and/or to produce certificates showing that the characteristic product quality values are met. This provides verifiable documentation showing that the characteristic product quality values are met.

In an advantageous embodiment of the invention, characteristic component quality values are determined from a component which contains a number of subcomponents. This achieves the effect that the characteristic component quality values of subassemblies which contain subcomponents comprising the product can be determined.

Further features and advantages of the invention emerge from the following description, which explains the invention on the basis of exemplary embodiments in conjunction with the attached drawings, in which:

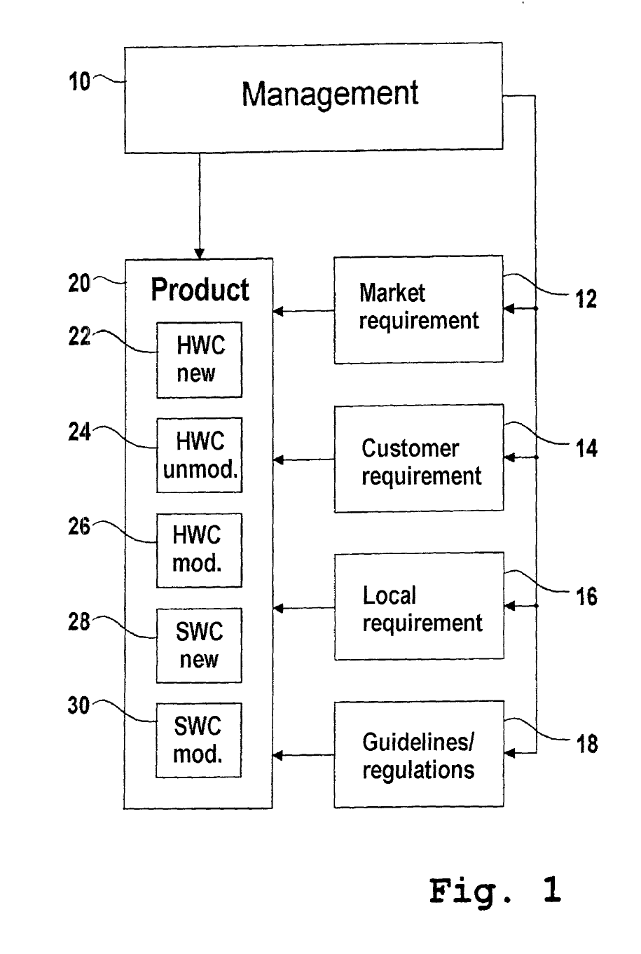

FIG. 1 shows a block diagram in which the product is schematically represented with the components contained in the product and with the influences of the sales components,

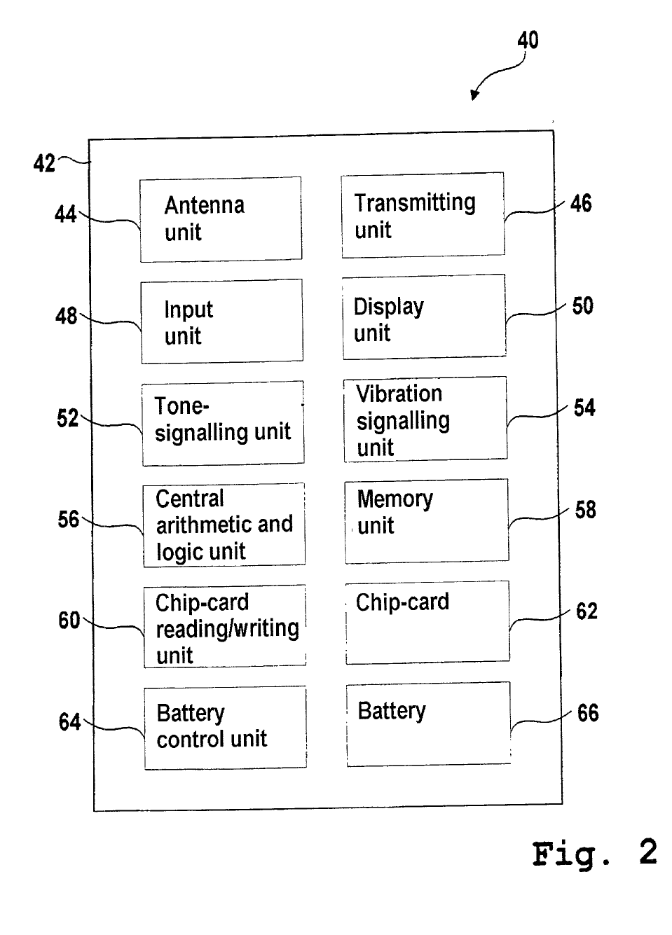

FIG. 2 shows a block diagram of a radio telephone which contains a number of components,

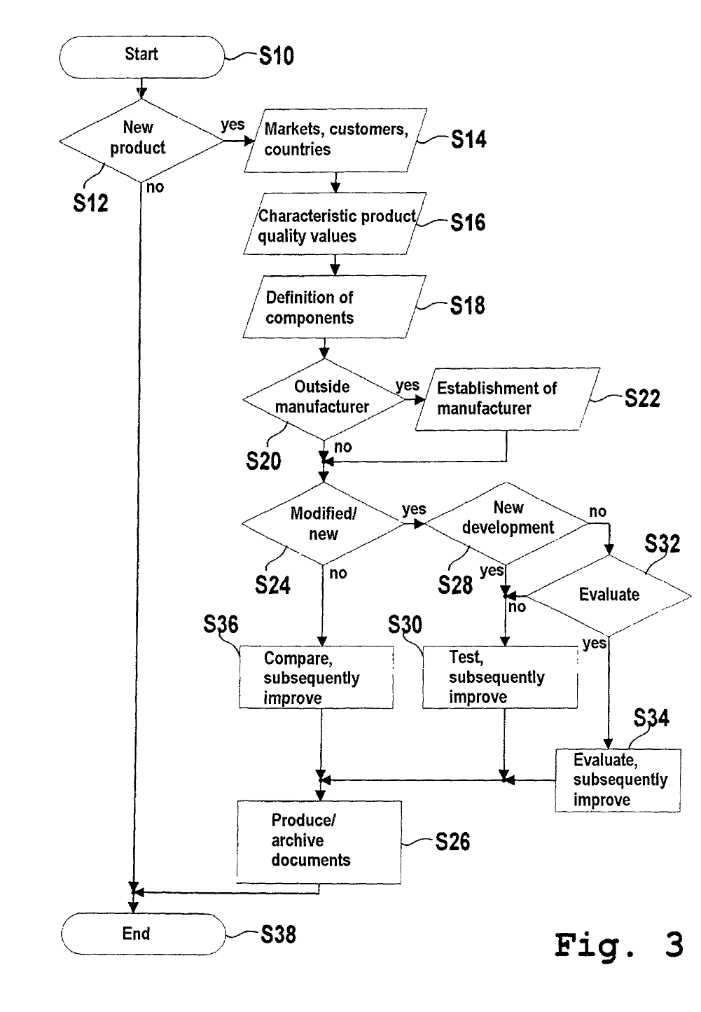

FIG. 3 shows a flow diagram in which method steps for developing a product while taking into consideration quality features of the product to be established are represented, and

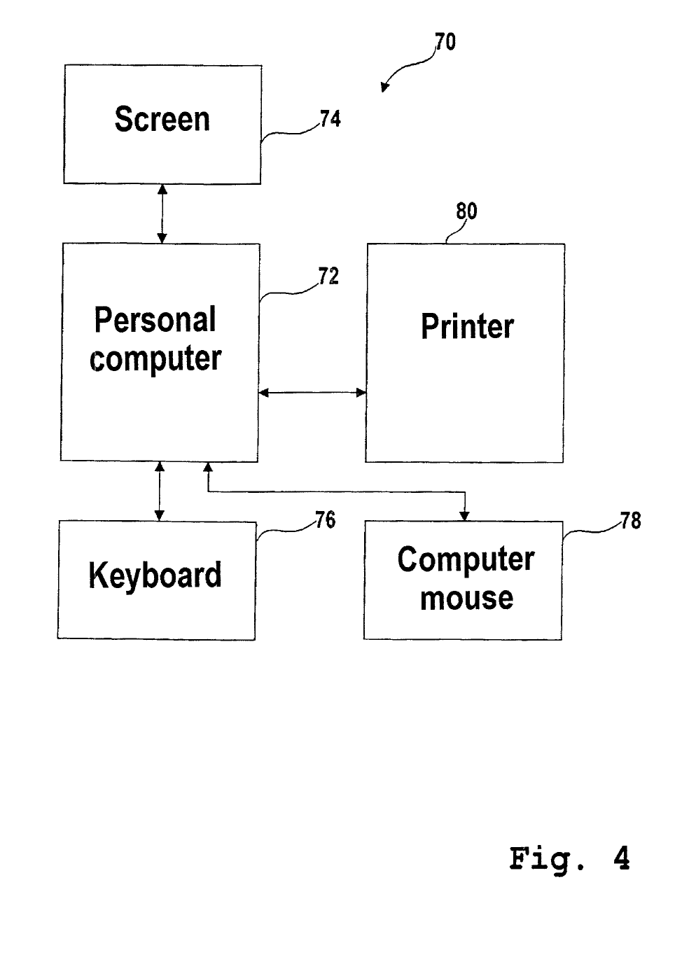

FIG. 4 shows the block diagram of a data processing installation which contains a number of components.

Represented in FIG. 1 is a block diagram which shows the major decision criteria for product development. A company management, denoted by 10, takes a decision to develop a certain product 20. When taking this decision, the management 10 also takes the decision on characteristic sales values, concerning in particular the sales region and potential customers. These characteristic sales values result in market requirements 12, customer requirements 14, local requirements 16 and also guidelines and regulations 18, which are to be taken into consideration during the development of the product 20. Hardware and software components are defined for the product 20 to be developed. This may involve defining hardware components 22 to be newly developed, already existing hardware components 24, existing hardware components 26 which have to be adapted for use in the product 20 to be newly developed, software components 28 to be newly developed and/or software components 30 which have to be adapted for use in the product 20 to be newly developed. During the definition of the product components 22, 24, 26, 28, 30, the quantifiable market requirements 12 are taken into consideration when defining the product components 22, 24, 26, 28, 30 and when establishing the characteristic product quality values.

Furthermore, the customer requirements 14 for the product to be newly developed are taken into consideration during the definition of the components 22 to 30. These customer requirements 14 may concern, for example, regulations of possible major customers and/or consumer behavior, for example the color, shape and/or accustomed operating practices of possible individual customers, in the respective sales region. The local requirements 13, which concern for example the climatic conditions and/or the frequency of earthquakes and also the possible places where possible customers will choose to use the product 20 to be developed, must also be taken into consideration.

The guidelines and regulations 18 applicable in the respective sales region are also taken into consideration during the definition of the components 22, 24, 26, 28, 30. Such guidelines and regulations 18 concern in particular regulations which apply in the respective sales region as a result of statutory provisions, such as for example laws and ordinances on environmental protection, the standards and guidelines for the approval of products, or as a result of the recognized rules of the art. The product must satisfy the necessary characteristic product quality values resulting from the requirements 12, 14, 16, 18 to allow it to be sold as intended in the respective sales region. The management 10 can, however, also establish characteristic product quality values for the product 20 to be developed which more than satisfy the characteristic product quality values resulting from the necessary requirements 12, 14, 16, 18, for example in order to develop a product 20 of a high quality.

During the definition of the components 22 to 30, at least one possible manufacturer for each individual component 22 to 30 is also established, aiming to obtain at least two possible manufacturers for a component. In the decision on the possible manufacturers, the commercial situation and/or the quality of manufactured products of the respectively possible manufacturer must also be taken into consideration. In contract negotiations with possible manufacturers, an assessment of the respective possible manufacturer should be carried out with the aid of a questionnaire, which also includes information on the established characteristic product quality values.

The respective possible manufacturer should also declare on this questionnaire that it has the possibility of carrying out tests which adequately demonstrate that the established characteristic product quality values are met and that said manufacturer will carry out these tests if commissioned with an order to do so. It should also declare its readiness to carry out any possibly necessary modifications and renewed tests of the component 22 to 30. Before or when a contract is concluded, the possible manufacturer must also declare that it will surrender to the commissioning agent documentation on the determined characteristic component quality values and/or the determined characteristic product quality values, and that it will allow the data contained in the documentation to be passed on to third parties, for example to final customers. It will also name at least one contact who will be available during the determination of the characteristic product quality values and, if need be, provide support for the determination of the characteristic product quality values in subsequent testing and the modification of the component 22 to 30.

If a number of manufacturers are envisaged for manufacturing the components 22 to 30, a manufacturer responsible for meeting the established characteristic product quality values is established. The manufacturers of the components 22 to 30 then have to agree with one another on how the established characteristic product quality values are satisfied. All the determined characteristic quality values should be confirmed by an accredited test laboratory.

In individual cases, it is possible to dispense with the determination of the characteristic product quality values while taking into consideration the influences of further components 22 to 30, if the individual components 22 to 30 satisfy the established characteristic product quality values and it is unlikely that the components 22 to 30 will influence one another.

For example, in Germany there is currently no requirement covering a data processing installation which includes a personal computer, a screen, a keyboard and a computer mouse to determine the characteristic product quality values of the entire data processing installation. In such a case, it is adequate if the individual components, i.e. the personal computer, the screen, the keyboard and the computer mouse, each satisfy the characteristic product quality values and that the characteristic component quality values of the personal computer, the screen, the keyboard and the computer mouse satisfy the established characteristic product quality values of the data processing installation, while it is unlikely for the characteristic product quality values to be surpassed by the characteristic component quality values even when the components are being used in the intended way with further components of the data processing installation.

The individual components, such as the personal computer, the screen, the keyboard and the computer mouse, may in this case each comprise a number of subcomponents. A personal computer includes, for example, a power supply unit, a hard disk drive, a floppy disk drive, a CD-ROM drive, a main board, a central arithmetic and logic unit, main memory modules, screen driver boards, sound cards and components for remote data transmission. A screen also contains a number of subcomponents, such as for example a high-voltage unit, a power supply unit, a control unit, a cathode-ray tube, an input unit, software which can be run by the control unit, and a housing.

When establishing the characteristic product quality values, characteristic values for CE marking, for UL approval, for NEBS approval, country-specific standards, in particular on earthquake safety, on the permissible fire load and on electromagnetic compatibility, and/or special customer requirements for the characteristic quality values should be taken into consideration. The characteristic product quality values determined and/or arising for the product from the characteristic component quality values are archived, and certificates showing that the characteristic product quality values are met are produced.

Represented in FIG. 2 is a radio telephone 40, which includes a number of components. The radio telephone 40 includes a housing 42, an antenna unit 44, a transmitting unit 46, an input unit 48, a display unit 50, a tone-signaling unit 52, a vibration-signaling unit 54, a central arithmetic and logic unit 56, a memory unit 58, a chip-card reading/writing unit 60, a chip card 62, a battery control unit 64 and a battery 66. The radio telephone 40 is in this case a product to be developed, like the product to be developed which is denoted by 20 in FIG. 1. The management 10 decides that a new radio telephone 40 is to be developed. This decision also includes the intended sales region for the radio telephone 40.

In accordance with an existing market analysis or a market analysis to be produced, technical parameters and functional parameters of the radio telephone 40 are established. Such a market analysis may also include the analysis of rival products sold in this sales region. When establishing the functions and technical parameters, further customer requirements, such as for example requirements of the mobile telephone network operators active in the sales region, are taken into consideration. Local requirements, such as for example special climatic and geographical conditions of the intended sales region, are also taken into consideration. Furthermore, the statutory provisions, in particular regulations on protection against tapping, on emergency call functions, on radio traffic, telecommunication laws, environmental protection laws and guidelines on electromagnetic compatibility, must be taken into consideration. With the aid of these requirements, characteristic product quality values for the radio telephone 40 are established. These characteristic product quality values take into consideration all the requirements imposed on the radio telephone 40.

If, for example, the radio telephone 40 is to be operated in the European Union and in the USA, the different transmitting and receiving frequencies and the different mobile telephone standards must also be taken into consideration for example. The management 10 can decide in such a case whether the radio telephone 40 is to be developed in such a way that transmission and reception of telecommunication data is to be possible in a switchable manner on all the frequencies possible in the intended sales region or whether an embodiment of the radio telephone 40 is to be developed for each of the possible transmission and reception frequencies. The requirements imposed on the radio telephone 40 to be developed, resulting from the market requirements 12, the customer requirements 14, the local requirements 16 and also the statutory guidelines and regulations 18, consequently represent minimum requirements for the radio telephone 40. Those statutory guidelines and regulations which are in preparation must also be taken into account.

The characteristic product quality values established by the management 10 for the radio telephone 40 to be developed may, however, also go beyond the minimum quality requirements and include further characteristic product quality values, such as for example the maximum standby time arising from the energy consumption and the battery capacity of the radio telephone 40 and the resultant maximum possible talk time.

Components 42 to 66, which are to be included in the radio telephone 40, are defined on the basis of the established properties and the established characteristic product quality values. In this embodiment, the components 42 to 46 are subassemblies of the radio telephone 40. It is checked whether components which have already been used in other products, such as for example the chip-card reading and writing unit 60, the display unit 50 or the input unit 48, can be taken over unmodified for the radio telephone 40. Furthermore, components 42 to 66 to be newly developed or components 42 to 66 to be modified are established. These components 42 to 66 may comprise hardware and/or software components. The manufacturer selection and the verification of the characteristic component quality values take place as already described in the description relating to FIG. 1.

If individual components 42 to 66 of the radio telephone 40 are newly developed or modified, characteristic component quality values of these components 42 to 66 are determined while taking into consideration the further components 42 to 66 of the radio telephone 40. These determined characteristic component quality values are compared with the established characteristic product quality values. If the characteristic component quality values do not satisfy the established characteristic product quality values, these components 42 to 66 are modified and modified characteristic component quality values are determined after the modification. These current modified characteristic component quality values are in turn compared with the established characteristic product quality values. The modification, the determination of the modified characteristic component quality values and the comparison of the modified characteristic quality values with the established characteristic product quality values are repeated until the characteristic product quality values are at least reached.

If the individual components 42 to 66 satisfy the requirements of the established characteristic product quality values, these components 42 to 66 are assembled to form the radio telephone 40. The current characteristic product quality values of this radio telephone 40 are then determined and in turn compared with the characteristic product quality values previously established during planning. If the determined current characteristic product quality values of the radio telephone 40 do not satisfy the established characteristic product quality values, at least one of the components 42 to 66 is modified. Subsequently, the modified characteristic product quality values of the radio telephone 40 are determined and again compared with the established characteristic product quality values. The characteristic product quality values represent desired values and the current determined characteristic component and/or product quality values represent actual values. With the aid of the method according to patent claim 1, a desired-value/actual-value comparison is carried out in the manner of a control loop. The modification of the respective component 42 to 66 or of the components is the manipulated variable of the control loop. The control is continued until the actual values have at least reached the desired values.

The modification and renewed determination of the characteristic product quality values of the radio telephone 40 are repeated until the established characteristic product quality values are at least reached. By meeting the characteristic product quality values, it is ensured that no infringements of applicable regulations, resulting in cost-intensive subsequent improvement of already produced radio telephones 40, occur when the radio telephone 40 is sold in the respective sales region. It is also ensured that, by taking into consideration the market requirements 12 and the local requirements 16, a radio telephone 40 of a high quality is developed, also corresponding to the specific requirements of the respective sales region and consequently having good prerequisites for achieving successful sales.

Represented in FIG. 3 is a signal flow diagram of a method of developing a product 20 while taking into consideration quality features to be established of the product 20. In step S10, the method is started. In step S12, it is checked whether a decision to manufacture a new product 20, for example a radio telephone 40, has been taken, for example by the management 10. If such a decision has been taken, characteristic sales values for the product 20, which take into consideration information on the intended sales regions, the intended markets, the intended customers, in particular the intended sales countries, is defined in step S14. Subsequently, in step S16, the characteristic product quality values for the product 20 to be developed are established. When establishing the characteristic product quality values, the requirements arising from the characteristic sales values established in step S14 are taken into consideration. In particular, customer requirements 14, local requirements 16 and applicable guidelines and regulations 18 are taken into consideration.

In step S18, the components 22 to 30 which are to be included in the product 20 are subsequently defined. Subsequently, in step S20, it is checked for each component 22 to 30 whether this component 22 to 30 is to be manufactured by an outside manufacturer. If this is the case, at least one possible manufacturer is established in step S22 for each component 22 to 30. The manufacturer selection takes place with the aid of what is known as an audit, with criteria which have already been described in the comments relating to FIG. 1. With the aid of such an audit, the performance capability and suitability of the manufacturer for manufacturing the respective component 22 to 30 is qualitatively assessed. Such an audit may take place for example with the aid of a questionnaire, on which the respective possible manufacturer has to provide suitable legally binding information and which becomes part of the contract if, for example, an order is commissioned.

Subsequently, it is checked in step S24 for each component 22 to 30 whether this component 22 to 30 must be newly developed or whether an existing component 22 to 30 must be modified. The check in step S24 is also carried out if it has been established in step S20 that the respective component 22 to 30 is not being manufactured by an outside manufacturer but at one's own company.

In other exemplary embodiments, in a decision as to whether the respective component 22 to 30 is to be manufactured by an outside manufacturer or at one's own company it is also possible to assess one's own company with the aid of the audit, the results of the audit being used to take the decision on whether the respective component 22 to 30 is manufactured at one's own company or by an outside manufacturer.

If it is established in step S24 that the respective component 22 to 30 is not to be newly developed and not to be modified, i.e. that the respective component 22 to 30 already exists and can be taken over unmodified for the product 20, it is subsequently checked in step S36 whether the existing characteristic component quality values also satisfy the established characteristic product quality values when this component 22 to 30 is combined with further components 22 to 30.

If the characteristic component quality values do not satisfy the established characteristic product quality values, this component 22 to 30 is modified and modified current characteristic component quality values are subsequently determined. The determined current: modified characteristic component quality values are compared with the established characteristic product quality values, modification of the component 22 to 30 continuing until the characteristic component quality values satisfy the established characteristic product quality values. Once this is the case, the results, i.e. the determined current characteristic component quality values and/or the determined current characteristic product quality values, are documented in the subsequent step S26. The characteristic product quality values represent desired values and the current determined characteristic component and/or product quality values represent actual values. With the current determined characteristic component or product quality values and the established characteristic product quality values, a desired-value/actual-value comparison is carried out in the manner of a control loop. The modification of the respective component or components is the manipulated variable of the control loop. The control is carried out until all the actual values have at least reached the desired values.

If, however, it is established in step S24 that the respective component 22 to 30 is to be newly developed or modified, it is subsequently checked in step S28 whether the component 22 to 30 is to be newly developed. If this is the case, the characteristic component quality values of the newly developed component 22 to 30 are subsequently determined in step S30 and compared with the established characteristic product quality values, with effects of the combination of this component 22 to 30 with the further components 22 to 30 of the product 20 being taken into consideration. If the established characteristic product: quality values are not reached by the current characteristic component quality values, the respective component 22 to 30 is subsequently improved and retested. The subsequent improvement and testing is repeated until all the established characteristic product quality values are at least reached by the current modified characteristic component quality values. Subsequently, in step S26, the possibly modified characteristic component quality values and/or the resulting characteristic product quality values are documented and archived.

If it is established in step S28 that the respective component 22 to 30 is not a new development, it is checked in step S32 whether the relevant characteristic product quality values can be derived from the characteristic component quality values of the original component. If this is the case, the characteristic component quality values of the modified component 22 to 30 are determined in step S34 from the characteristic component quality values of the original component while taking into consideration influences of the further components 22 to 30, and are subsequently documented and archived in step S26.

If, however, it is established in step S32 that it is not possible to derive the characteristic component quality values of the modified component 22 to 30 from the characteristic component quality values of the original component, the characteristic component quality values of the modified component 22 to 30 are determined in step S30 and compared with the characteristic product quality values previously established during planning. If the established characteristic product quality values are not at least reached by the determined characteristic component quality values, the respective component 22 to 30 is subsequently improved and modified characteristic component quality values are determined. This operation is repeated until the characteristic component quality values have reached the established characteristic product quality values. Subsequently, in step S26, the determined and possibly modified characteristic component quality values and the characteristic product quality values arising from the characteristic component quality values are documented and archived. Once checking of all the components 22 to 30 of the product 20 has been completed, furthermore, a certificate showing that the respective quality requirements are met is issued in step S26. The method is subsequently ended in step S38. The method is likewise ended in step S38 if it has been established in step S12 that no new product is to be developed.

The characteristic component quality values and/or the characteristic product quality values should be determined by an accredited test laboratory. For a newly developed or modified component 22 to 30, the manufacturer of the component 22 to 30 may also determine the characteristic component quality values in a non-accredited test laboratory. However, once the respective component 22 to 30 satisfies the established characteristic product quality values, the determined characteristic component quality values should be confirmed by an accredited test laboratory.

Represented in FIG. 4 is a data processing installation 70, which includes components 72 to 80. The data processing installation 70 has a personal computer 72, which is connected with the aid of data lines (not represented) to a screen 74, a keyboard 76, a computer mouse 78 and to a printer 80. In this exemplary embodiment, there is evidence for each of the components 72 to 80 of the data processing installation 70 that the characteristic product quality values established for the data processing installation 70 are met. For products such as the data processing installation 70 it is not necessary in most sales regions, such as also in Germany for example, to determine the characteristic product quality values of the data processing installation 70. With the aid of the characteristic component quality values of the components 72 to 80, the manufacturer of the data processing installation 70 can issue certificates showing that the established characteristic product quality values for the data processing insulation 70 are met.

1. A method of developing a product while taking into consideration quality features of the product to be established,
in which method characteristic sales values which relate at least to the intended sales region are established for the product (20) to be developed, the characteristic product quality values to be satisfied by the product (20) are established, consideration being given to the regulations and guidelines arising from the characteristic sales values,
at least two components (22 to 30) which are to be included in the product (20) are defined for the product (20), in a test procedure it is checked for each component (22 to 30) whether the established characteristic product quality values are achieved by the characteristic component quality values determined for this component (22 to 30) even when this component (22 to 30) is combined with the further component (22 to 30, and
in which, if the result of the test is negative, the component (22 to 30) is modified and the test procedure is repeated, with the modified characteristic component quality values being used as the characteristic component quality values.

2. The method as claimed in claim 1, characterized in that the characteristic product quality values are determined from the possibly modified characteristic component quality values using a method of evaluation, with empirical estimating methods, mathematical models and simulation methods preferably being used as methods of evaluation.

3. The method as claimed in one of the preceding claims, characterized in that the current characteristic product quality values are determined by direct measuring and/or testing on the product.

4. The method as claimed in one of the preceding claims, characterized in that the components are hardware components (22, 24, 26) and/or software components (28, 30).

5. The method as claimed in one of the preceding claims, characterized in that characteristic quality variables of possible manufacturers of the individual components (22 to 30) are also taken into consideration in the definition of the components (22 to 30).

6. The method as claimed in claim 5, characterized in that the performance capability, the commercial situation and/or the quality of manufactured products are assessed to establish the characteristic quality variables of a manufacturer.

7. The method as claimed in claim 6, characterized in that the assessment is carried out with the aid of a questionnaire, which also contains information on the established characteristic product quality values, in that it is also taken into consideration to what extent there are possibilities for tests which adequately demonstrate that the established characteristic product quality values are met.

8. The method as claimed in one of claims 5 to 7, characterized in that a possible manufacturer declares its readiness, if commissioned with an order, to carry out tests and possibly necessary modifications of the component to satisfy the characteristic product quality values.

9. The method as claimed in claim 8, characterized in that the manufacturer surrenders to the commissioning agent documentation on the determined characteristic component quality values and/or characteristic product quality values and allows such documentation to be passed on to third parties, in particular to final customers.

10. The method as claimed in one of claims 5 to 9, characterized in that the possible manufacturer of the component (22 to 30) names at least one contact who will be available during the determination of characteristic product quality values and, if need be, at least provide support for the determination of the characteristic product quality values in subsequent testing and modification of the component (22 to 30).

11. The method as claimed in one of claims 1 to 10, characterized in that it is taken into consideration during the definition of the components (22 to 30) and/or when establishing the possible manufacturers that there are at least two manufacturers who can manufacture the respective component (22 to 30).

12. The method as claimed in one of the preceding claims, characterized in that the product (20) includes components (22 to 30) which have been manufactured by at least two manufacturers, and in that a manufacturer responsible for meeting the established characteristic product quality values is established.

13. The method as claimed in one of the preceding claims, characterized in that all the determined characteristic quality values are confirmed by an accredited test laboratory.

14. The method as claimed in one of the preceding claims, characterized in that it is contractually agreed with the manufacturers of the respective component (22 to 30) that the established characteristic product quality values will be met and/or characteristic component quality values which arise for the respective component from the characteristic product quality values will be met.

15. The method as claimed in one of the preceding claims, characterized in that the characteristic product quality values are not determined by direct measurement and/or testing if it is not only the case that the individual components (72 to 78) satisfy the established characteristic product quality values but it is also unlikely that the components (72 to 78) will influence one another.

16. The method as claimed in one of the preceding claims, characterized in that the characteristic sales values take into consideration the target market, intended sales countries and/or possible customers.

17. The method as claimed in one of the preceding claims, characterized in that a component (22 to 30), in particular a subassembly, contains a number of subcomponents.

18. The method as claimed in one of the preceding claims, characterized in that, when establishing the characteristic quality values, characteristic values for CE marking, for UL approval, for NEBS approval, country-specific standards, in particular on earthquake safety, on the permissible fire load and on electromagnetic compatibility, and/or special customer requirements (14) for characteristic quality values are taken into consideration.

19. The method as claimed in one of the preceding claims, characterized in that the characteristic product quality values determined and/or arising for the product from the characteristic component quality values are archived and/or certificates showing that the characteristic product quality values are met are produced.
